(19) United States
(12) Patent Application Publication
(10) Pub. No.: US 2009/0217493 A1
(43) Pub. Date: Sep. 3, 2009

(54) HOOP RETAINING RING

(76) Inventor: MICHAEL GREENHILL, Highland Park, IL (US)

Correspondence Address: PATENT GROUP;C/O DLA PIPER US LLP, 203 N. LASALLE ST., SUITE 1900, CHICAGO, IL, 60601, US

(21) Appl. No.: 12/392,713

(22) Filed: Feb. 25, 2009

Related U.S. Application Data
(60) Provisional application No. 61/032,311, filed on Feb. 28, 2008.

(51) Int. Cl. A44B 21/00; F16D 1/116

(52) U.S. Cl. 24/457; 403/332

(57) ABSTRACT

Retaining rings can be used either externally on a shaft or internally within a bore are provided to form assemblies that can retain a component adjacent to the shaft or bore. The retaining rings can have a rectangular cross-section, and an axial thickness greater than the radial width. Components retained by such retaining rings can have a chamfered or radiused edge, and can overhang the retaining ring. The thrust load applied to the retaining rings can have an axial portion and a radial portion.

### RELATED APPLICATIONS

This application claims the benefit of U.S. Provisional Patent Application Ser. No. 61/032,311, to Michael Greenhill, entitled “Hoop Retaining Ring,” filed on Feb. 28, 2008, currently pending.

### BACKGROUND

The present technology generally relates to retaining rings that can be used either externally on a shaft or internally within a bore.

Generally, retaining rings are fastening devices that fit on a shaft or in a bore to retain components in an axial position on the shaft or in the bore where they are situated. There are several types of retaining rings. Examples of retaining rings include “circlips” that are stamped from sheet or strip metal, “spiral” retaining rings that can be single or multiple turns and are formed from flat wire, “round wire” retaining rings formed from round wire, and others. Retaining rings conventionally have an axial thickness that is smaller than their radial width. This means that the distance that such clips extend in a direction perpendicular to the shaft, the radial width, is greater than the distance they extend along the shaft, the axial thickness.

Conventional retaining rings are positioned in a groove that has been machined into the exterior surface of a shaft or the interior surface of a bore. The ring, as installed in its operating position in the groove, forms a shoulder that components ride up against, thereby, preventing the components from moving axially past the ring. Conventional retaining rings are designed to accommodate thrust loads in a purely axial direction.

Retaining rings are preferably removable. Accordingly, components on a shaft that are held in position by a retaining ring may be removed from the shaft by first removing the retaining ring and then sliding the components past the groove in which the retaining ring was positioned.

The design of a groove in which a retaining ring will be positioned is generally determined by the configuration of the retaining ring selected. For example, a conventional retaining ring is seated in a groove that is typically a depth of approximately 30%-50% of the retaining ring's radial width. Retaining rings seated in such a groove typically extend radially above a shaft, or within a bore, a distance of approximately 50%-70% of the retaining ring's radial width.

In general applications, the thrust capacity of a retaining ring that is installed in its groove increases as the depth of the groove increases. The main reason is grooves that are more shallow tend to result in the ring twisting or dishing as load is applied. FIG. 3, for example, illustrates a typical retaining ring 32, in a groove on a shaft 30, with a thrust load being applied by a component 34. As the component 34 applies a thrust load to the retaining ring 32, the ring shifts to the position 32a, resulting in axial shift of the component 34 by an amount X. The groove continues to deform rapidly as load is further applied to the ring, increasing the dishing of the ring that eventually contacts and mushrooms the groove wall causing failure as the ring extrudes out. Deformation of the groove wall is illustrated, for example, in FIG. 7. As shown, a component 72 is applying a thrust load to retaining ring 74, which is positioned in a groove in shaft 70. The retaining ring 74 is dishing by an amount D, causing a deformation 76 in the shaft. Such dishing is the most common failure mode of any rectangular section retaining ring. Groove deformation, such as that illustrated in FIG. 7, can occur in instances where the shaft or bore is formed of materials such as aluminum, cold rolled steel, low carbon or mild steel or other softer materials. In situations like this, design engineers will often specify custom rings made specifically for deeper grooves or rings with an increased thickness to fit into wider grooves, thereby providing increased thrust capacity. Such rings are much harder to remove from the groove and are often damaged when removing or reinstalling

One option for mechanical designers is to increase the depth of the groove to maximize thrust capacity of the assembly. The trade-off is that increased groove depth results in decreased shaft wall thickness at the retaining ring position, thus weakening the shaft. In many applications, the groove depth is restricted by the size of the shaft and the construction of the shaft. In the case of a thin walled sleeve, the radial cross-section of the shaft (i.e. the wall of the tube) would limit the depth of the groove. In this situation, designers are often prevented from using retaining rings because rings are often designed for grooves that would be too deep for the application. Sometimes engineers design special retaining rings for use in such applications, which tends to result in limiting thrust capacity.

Many ring manufacturers offer a choice of retaining rings for different thrust capacities. In the situation of a light duty application, the groove depth would be shallower than for other rings designed to handle higher thrust capacity. Groove standards were established many years ago by U.S. military and aircraft specifications Many retaining ring manufacturers adopted these specifications for imperial ring manufacturing. DIN Standards for retaining ring grooves were also established years ago in Europe as European engineering standards, and many OEM's have adopted these metric specifications as standard. In either standard, the retaining rings and grooves are designed to handle heavy thrust loads. This being the case, the majority of retaining rings specified worldwide are designed using the established world standards for heavy thrust capacity applications.

Components being retained on a shaft, or within a bore, generally have a radial width that is greater than the radial section of the retaining ring that extends radially beyond the shaft or bore in which the retaining ring is seated. The surface of the component that contacts the ring is often flat and presses evenly across the entire radial section of the retaining ring. In some applications, however, the component that presses against the retaining ring may not be even, or may have a radius or chamfer that doesn't press evenly against the radial section of the ring. Examples of such situations include times when a component has a chamfered or radiused edge, and when the component is not concentric to the shaft or bore such that there is a clearance between the two components. As illustrated in FIG. 1, for example, a retaining ring 12 is positioned in a groove on shaft 10, and a component 14 having a chamfered edge is in contact with the retaining ring 12. In FIG. 2, a retaining ring 22 is in a groove on shaft 20, and a component 24 having a radiused edge is in contact with the retaining ring 22. In FIG. 4, a retaining ring 42 is in a groove on a shaft 40, with component 44 in contact with the retaining ring. There is a clearance C between the component 44 and the shaft 40. FIG. 5 illustrates a retaining ring 52 in a groove on a shaft 50, and a component 54 in contact with the retaining ring 52. The sides of the groove in the shaft 50 are uneven, resulting in a step of an amount S between one side of the groove and the other. In each of the situations illustrated in FIGS. 1, 2, 4 and 5, a moment arm can result, which tends to dish the ring and cause ring failure. Generally, the objective of a mechanical design is to avoid such conditions.

The shaft material, and thus the strength of the groove wall, also plays a role in design assemblies utilizing retaining rings. About 95% of applications tend to utilize heat-treated and hardened retaining rings in groove materials that are significantly softer than the ring material. In instances where the shaft or bore is formed of hardened material, such as hardened steel, ring shear can occur. FIG. 6 illustrates an example of ring shear. As illustrated in FIG. 6, ring 64, positioned in a groove on shaft 60 made of hardened steel, has sheared due to the thrust load applied to the ring 64 by component 62. In such instances, as external force is applied to the ring 64 by the component 62, the ring 64 can start to dish, but the hardened material of the shaft 60 does not deform or mushroom like soft steel tends to under such circumstances. When the force applied by the component 62 becomes sufficiently high, the retaining ring 64 can shear.

### BRIEF SUMMARY

The present technology generally relates to retaining rings that can be used either externally on a shaft or internally within a bore. Such retaining rings can be utilized to retain a component adjacent to a shaft or bore, thus forming an assembly.

In one aspect a retaining ring for use externally on a shaft or internally within a bore is provided, the retaining ring including a rectangular cross-section having an axial thickness and a radial width, where the axial thickness is greater than the radial width.

In another aspect, an assembly utilizing a retaining ring to retain a component adjacent to a shaft or bore is provided that includes a groove for receiving a retaining ring, a retaining ring received within the groove, and an adjacent component in contact with the retaining ring that is retained adjacent to the shaft or bore by the retaining ring. The groove can be located on a shaft or in a bore. The retaining ring can include a rectangular cross-section having an axial thickness and a radial width, where the axial thickness greater than the radial width.

### BRIEF DESCRIPTION OF SEVERAL VIEWS OF THE DRAWINGS

Specific examples have been chosen for purposes of illustration and description, and are shown in the accompanying drawings, forming a part of the specification.

FIG. 1 is a cross-sectional view of a known retaining ring positioned in a groove on a shaft in contact with a chamfered component.

FIG. 2 is a cross-sectional view of a known retaining ring positioned in a groove on a shaft in contact with a radiused component.

FIG. 3 is a cross-sectional view of a known retaining ring positioned in a groove on a shaft in contact with a component, where the retaining ring is dishing.

FIG. 4 is a cross-sectional view of a known retaining ring positioned in a groove on a shaft in contact with a chamfered component, where there is a clearance between the shaft and the component.

FIG. 5 is a cross-sectional view of a known retaining ring positioned in a groove on a shaft in contact with a chamfered component, where the groove includes a step.

FIG. 6 is a cross-sectional view of a known retaining ring positioned in a groove on a shaft in contact with a component, where the ring has sheared.

FIG. 7 is a cross-sectional view of a known retaining ring positioned in a groove on a shaft in contact with a component, where the groove has become deformed.

FIG. 8 is a perspective view of one embodiment of a retaining ring of the present technology positioned in a groove on a shaft.

FIG. 9A is a top elevational view of one embodiment of a retaining ring of the present technology that can be utilized in a groove on a shaft.

FIG. 9B is a side elevational view of the retaining ring of FIG. 9A.

FIG. 10 is a perspective view of one embodiment of a retaining ring of the present technology positioned in a groove in a bore.

FIG. 11A is a top elevational view of one embodiment of a retaining ring of the present technology that can be utilized in a groove in a bore.

FIG. 11B is a side elevational view of the retaining ring of FIG. 11A.

FIG. 12A is a cross-sectional view of one embodiment of a retaining ring of the present technology positioned in a groove on a shaft in contact with a chamfered component.

FIG. 12B is a cross-sectional view of the retaining ring of FIG. 12A, showing the directional components of the thrust exerted by the component.

FIG. 13 is a cross-sectional view of one embodiment of a retaining ring of the present technology positioned in a groove on a shaft in contact with a radiused component.

FIG. 14 is a cross-sectional view of one embodiment of a retaining ring of the present technology positioned in a groove on a shaft in contact with a square edged component.

FIG. 15 is a cross-sectional view of one embodiment of a retaining ring of the present technology positioned in a groove on a shaft in contact with a component that overhangs the retaining ring.

FIG. 16 is a perspective view of one embodiment of a retaining ring of the present technology positioned in a groove on a shaft.

FIG. 17A is a perspective view of one embodiment of a retaining ring of the present technology.

FIG. 17B is a top elevational view of the retaining ring of FIG. 17A.

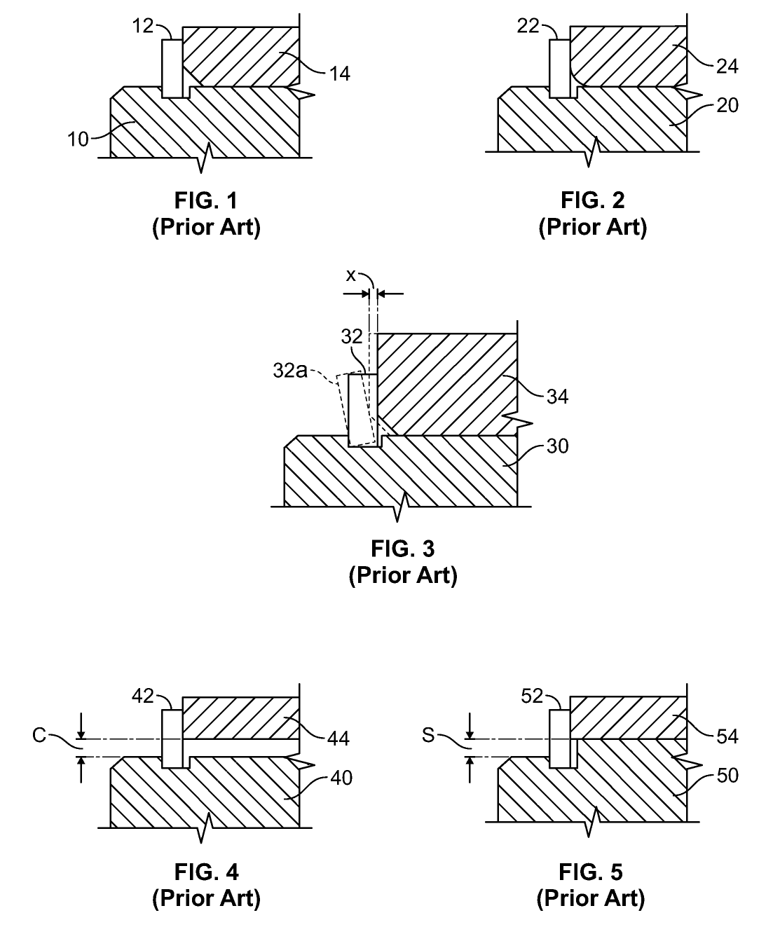

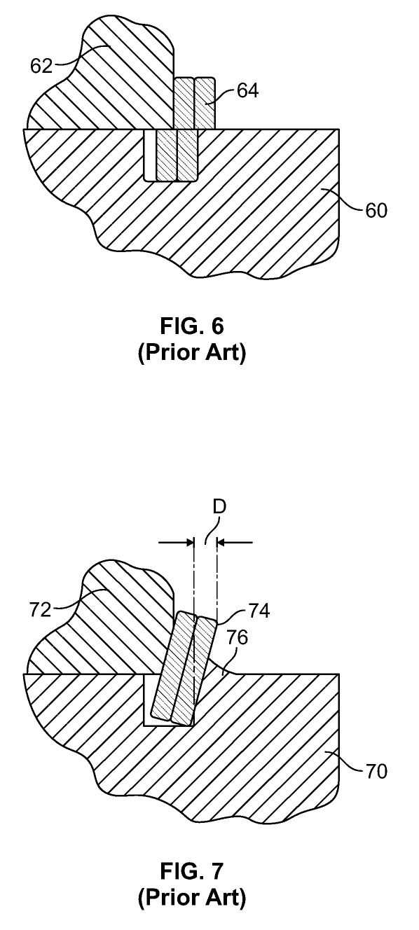

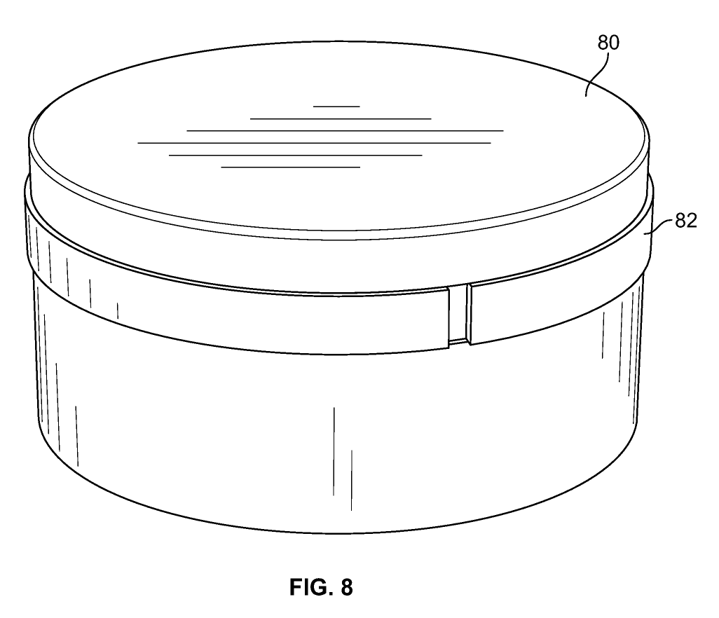

### DETAILED DESCRIPTION

Retaining rings are generally used by positioning them in a groove that is located on a shaft or within a bore. In various applications, retaining rings can be utilized to retain a component adjacent to a shaft or bore, thus forming an assembly. Such assemblies can include a groove for receiving a retaining ring, the groove being located on a shaft or in a bore, a retaining ring, and a component in contact with the retaining ring that is retained adjacent to the shaft or bore by the retaining ring.

In preferred embodiments, the retaining rings disclosed herein have a smaller radial profile than conventional retaining rings, and can be positioned in grooves having shallower depths. Preferably, thrust loads applied to the retaining rings disclosed herein have both an axial and a radial component.

The unique retaining rings of the present technology preferably have a rectangular cross-section having an axial thickness, in a direction along the shaft or bore, and a radial width, in a direction perpendicular to the shaft or bore. The axial thickness of the retaining rings is greater than the radial width.

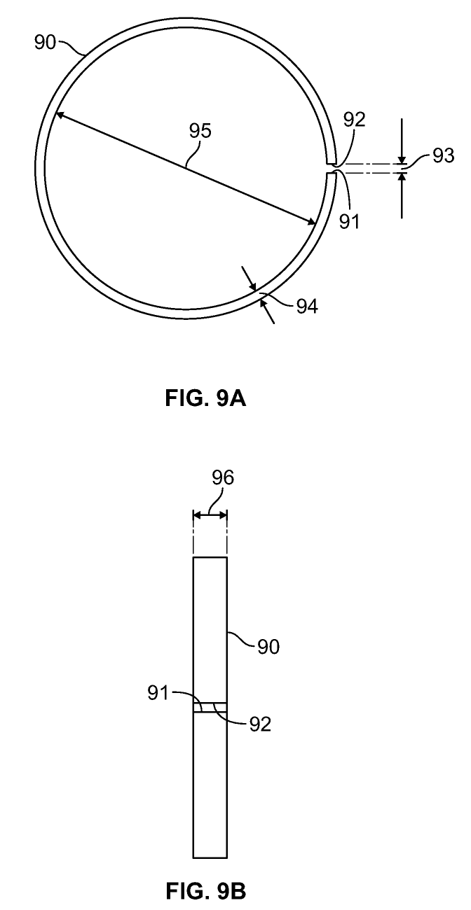

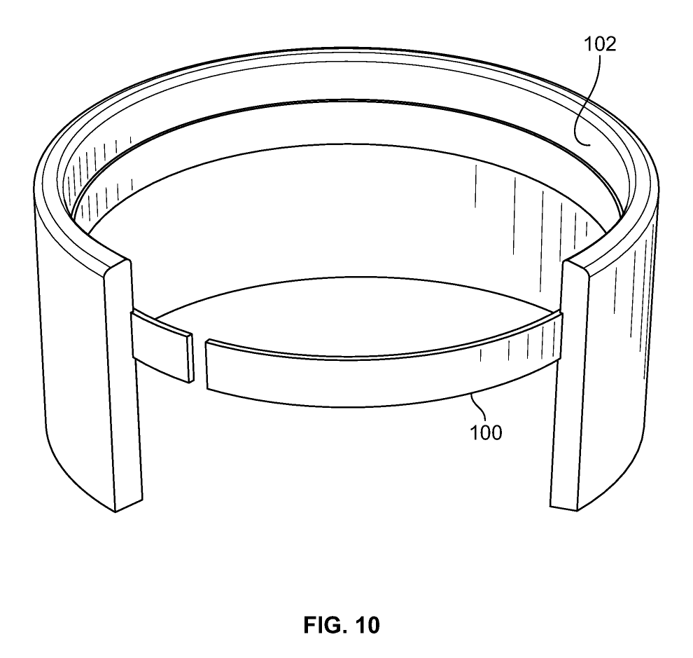

FIGS. 8, 9A and 9B illustrate some embodiments of external retaining rings for installation in a groove on a shaft. FIG. 8 shows an external retaining ring 82 positioned in a groove on a shaft 80. Shaft 80 is cylindrical, and has a groove extending around its circumference to receive the retaining ring 82. FIGS. 9A and 9B show an external retaining ring 90 that can also be positioned in a groove on a shaft. Retaining ring 90 has a first end 91, a second end 92 that is separated from the first end by a distance 93, a radial width 94, and an axial thickness 96. The axial thickness 96 of the retaining ring 90 is greater than the radial width 94 of the retaining ring 90. The retaining ring is circular, or substantially circular, in shape, to fit within a groove on a cylindrical shaft, and the retaining ring 90 has an inner diameter 95. The inner diameter 95 of the external retaining ring 90 can be sized to fit the diameter of the groove on the shaft, and preferably forms a tight or snug fit in the groove.

The retaining ring 90 can have any dimensions suitable for the intended application. In some example, retaining ring 90 can be formed from one turn of metal having a rectangular cross section. In a first example, the retaining ring 90 can have a radial thickness of from about 0.0235 inches to about 0.0265 inches, an axial thickness of from about 0.084 inches to about 0.092 inches, a separation between the first end 91 and the second end 92 of from about 0.015 inches to about 0.065 inches, and an inner diameter of from about 0.696 inches to about 0.711 inches. A retaining ring 90 having such dimensions can be utilized, for example, on a shaft having a diameter of about 0.75 inches, with a groove having a groove diameter of about 0.726 inches and a minimum groove axial thickness of about 0.093 inches. In a second example, the retaining ring 90 can have a radial thickness of from about 0.033 inches to about 0.037 inches, an axial thickness of from about 0.146 inches to about 0.154 inches, a separation between the first end 91 and the second end 92 of from about 0.020 inches to about 0.090 inches, and an inner diameter of from about 1.416 inches to about 1.436 inches. A retaining ring 90 having such dimensions can be utilized, for example, on a shaft having a diameter of about 1.5 inches, with a groove having a groove diameter of about 1.466 inches and a minimum groove axial thickness of about 0.156 inches. In a third example, the retaining ring 90 can have a radial thickness of from about 0.044 inches to about 0.048 inches, an axial thickness of from about 0.220 inches to about 0.230 inches, a separation between the first end 91 and the second end 92 of from about 0.025 inches to about 0.150 inches, and an inner diameter of from about 2.865 inches to about 2.895 inches. A retaining ring 90 having such dimensions can be utilized, for example, on a shaft having a diameter of about 3 inches, with a groove having a groove diameter of about 2.955 inches and a minimum groove axial thickness of about 0.232 inches.

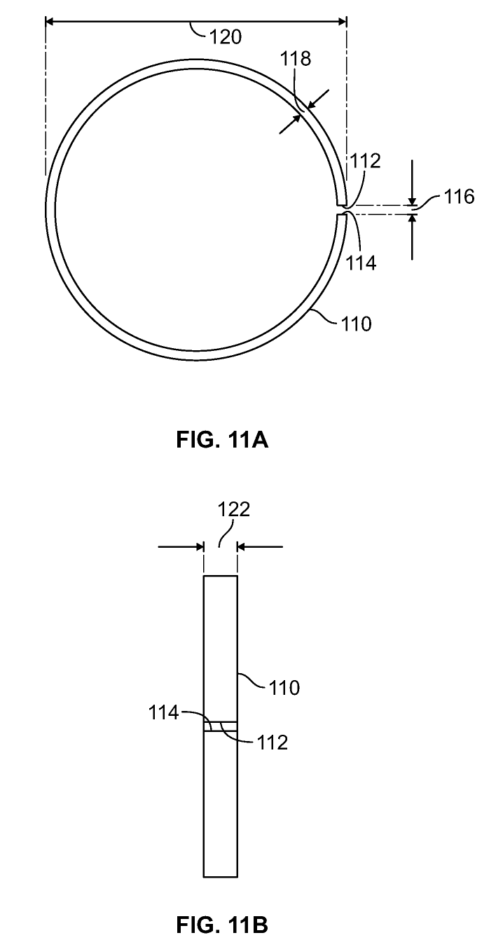

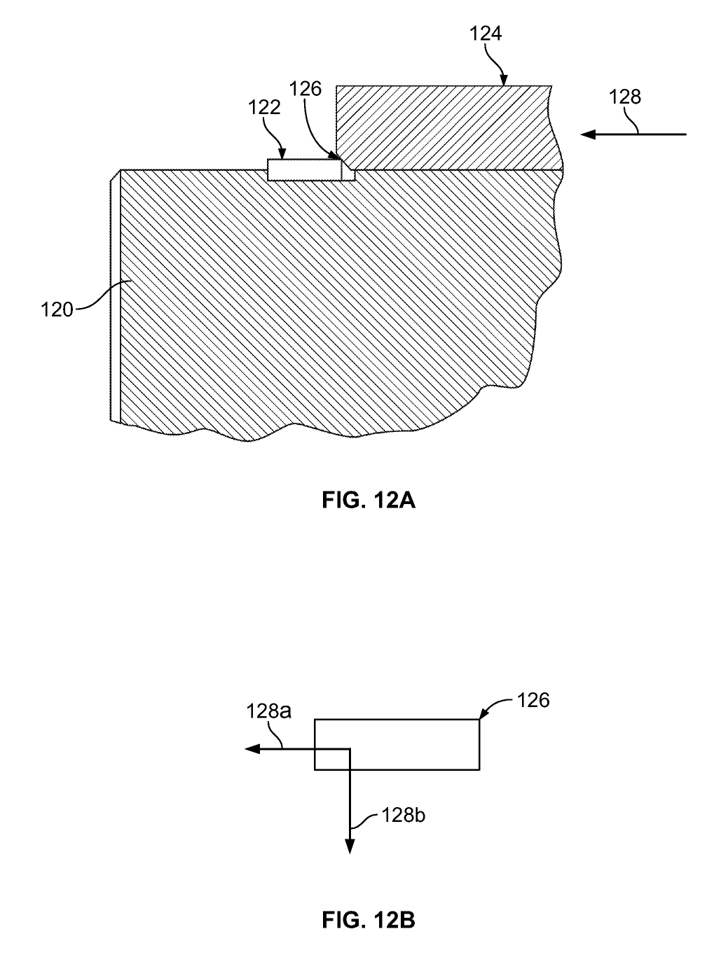

FIGS. 10, 11A and 11B illustrate some embodiments of internal retaining rings for installation in a groove within a bore. FIG. 10 shows a cut-away of a bore 102, and an internal retaining ring 100 positioned in a groove within the bore 102. FIGS. 11A and 11B show an internal retaining ring 110 that can also be positioned in a groove in a bore. Retaining ring 110 has a first end 112, a second end 114 that is separated from the first end by a distance 116, a radial width 118, and an axial thickness 122. The axial thickness 122 of the retaining ring 110 is greater than the radial width 118 of the retaining ring 110. The retaining ring 110 is circular, or substantially circular, in shape, to fit within a groove in a cylindrical bore, and the retaining ring 110 has an outer diameter 120. The outer diameter 120 of the internal retaining ring 110 can be sized to fit within the circumferential dimension of the groove in the bore.

The retaining ring 110 can have any dimensions suitable for the intended application. In some examples, retaining ring 110 can be formed from one turn of metal having a rectangular cross section. In a first example, the retaining ring 110 can have a radial thickness of from about 0.0235 inches to about 0.0265 inches, an axial thickness of from about 0.084 inches to about 0.092 inches, a separation between the first end 112 and the second end 114 of from about 0.015 inches to about 0.065 inches, and an outer diameter of from about 0.789 inches to about 0.804 inches. A retaining ring 110 having such dimensions can be utilized, for example, in a bore having an inner diameter of about 0.75 inches, with a groove having a groove diameter of about 0.774 inches and a minimum groove axial thickness of about 0.093 inches. In a second example, the retaining ring 110 can have a radial thickness of from about 0.0235 inches to about 0.0265 inches, an axial thickness of from about 0.084 inches to about 0.092 inches, a separation between the first end 112 and the second end 114 of from about 0.015 inches to about 0.065 inches, and an outer diameter of from about 1.044 inches to about 1.064 inches. A retaining ring 110 having such dimensions can be utilized, for example, on a shaft having a diameter of about 1.0 inches, with a groove having a groove diameter of about 1.024 inches and a minimum groove axial thickness of about 0.093 inches. In a third example, the retaining ring 110 can have a radial thickness of from about 0.033 inches to about 0.037 inches, an axial thickness of from about 0.146 inches to about 0.154 inches, a separation between the first end 112 and the second end 114 of from about 0.020 inches to about 0.090 inches, and an outer diameter of from about 1.564 inches to about 1.584 inches. A retaining ring 110 having such dimensions can be utilized, for example, on a shaft having a diameter of about 1.5 inches, with a groove having a groove diameter of about 1.534 inches and a minimum groove axial thickness of about 0.156 inches.

Preferred embodiments of retaining rings have a natural spring tension, or radial force, to facilitate the ring seating itself in a groove. The stability of a retaining ring can be increased by increasing its axial thickness, which increases the natural spring tension of the retaining ring. However, as ring stability increases, the flexibility decreases. A desired level of stability and flexibility can be achieved so that the retaining ring retains its position in a groove, but is also sufficiently flexible so that it can be easily installed and removed. Some examples of preferred retaining rings can have a ratio of axial thickness to radial width of about 20:1 or less, and preferably about 3:1 or greater. Ratios over 3:1 can increase the stability of the retaining ring, but an increase in the axial thickness results in an increase in the groove thickness required to receive the retaining ring.

Additionally, it is preferred that retaining rings of the present technology be circular, or substantially circular, in order to fill as much of the groove depth as possible. In some examples, a minimum of 85% of the circumference of the retaining ring can have a maximum standoff between the ring and the groove of up to about 0.002 inches. In other examples, a maximum of 15% of the circumference of the retaining ring can have a maximum standoff between the ring and the groove of up to about 0.004 inches.

The preferred groove depth for retaining rings disclosed herein can be significantly less than groove depths normally associated with conventional retaining rings. Accordingly, retaining rings of the present technology can be mounted or positioned in a relatively shallow groove. Conventionally, it is common practice to specify a groove depth of from about 30% to about 50% of a conventional retaining ring's radial width. The same specification can be utilized with retaining rings of the present technology. However, because the radial width of the current retaining rings can be substantially less than the radial width of conventional retaining rings, the resultant groove depth can be substantially reduced as compared to conventional groove depths. The shallow groove depth that can be utilized to mount retaining rings of the present technology can provide significant advantages in thin walled sleeves. In at least one example, where groove depth is calculated at a 50% value, a 1 inch diameter retaining ring can extend about 0.012 inches radially above a shaft or bore and about 0.012 inches deep forming the groove depth. Because the groove is shallow, there is not the conventional amount of groove depth to seat the ring in position. Accordingly, it is preferred that the corners of the groove be sharply defined, so that the retaining ring can be seated properly in a manner that abuts a substantial portion of the groove wall, and preferably the entire groove wall.

Retaining rings of the present technology do not tend to dish or twist when force is applied, which can allow for much greater thrust capacity of the assembly in which the retaining ring is installed. Without being bound by any particular theory, it is believed that the mechanical advantage created by the form of the retaining rings of the present technology resists dishing, and that the moment arm of a conventional retaining ring can be significantly reduced or eliminated such that the thrust capacity depends at least primarily on the support provided by the groove. The thrust capacity of the assembly can thus be determined by the groove specifications, including edge margin. Edge margin is the distance the groove is placed away from the end of the shaft or bore. Calculations of edge margin are generally considered in determining the thrust capacity of the assembly. Groove failure are also generally considered in determining thrust capacity of the retaining rings of the present technology, but unlike conventional retaining rings, dishing is not present thus allowing for greater capacity of the groove. Another consideration occurs when the groove material is heat treated to a hardness equal to or greater than the retaining ring. In such examples, the thrust capacity of the retaining ring can be determined and limited by ring shear since the groove will not deform with an applied force.

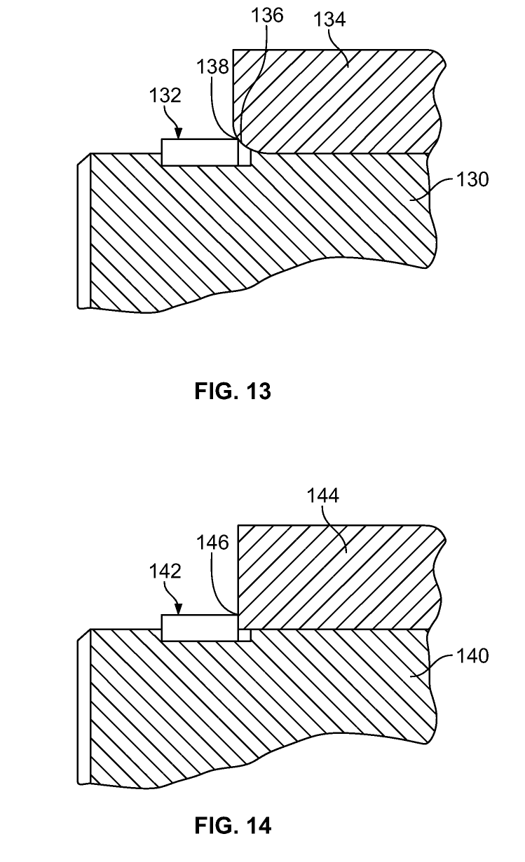

Retaining rings of the present technology are preferably utilized in assemblies where the thrust load applied by the adjacent component will be bi-directional, having both an axial portion and a radial portion. Without being bound by any particular theory, it is believed that the unique design parameters of the presently disclosed retaining rings result in increased thrust capacity under such conditions. As illustrated in FIGS. 12A and 12B, the adjacent component 124 abutting the retaining ring 122, which is positioned in a groove on a shaft 120, can have an angular contact surface that contacts the retaining ring 122 at a contact point 126. The thrust 128 of the component 124 as exerted on the retaining ring at the contact point 126 has an axial portion 128a and a radial portion 28b. In another example, as illustrated in FIG. 13, an adjacent component 134 can have a radiused edge that makes contact with a retaining ring 132 at a contact point 138. Retaining ring 132 is positioned in a groove on shaft 130. In some examples, as illustrated in FIG. 14, where a retaining ring 142 is positioned in a groove on a shaft 140, a direct contact between an adjacent component 144 and a retaining ring 142, such as the type of contact typically utilized with conventional retaining rings, can occur at a contact surface 146. Such direct contact can be suitable for some applications, although the thrust capacity of the retaining ring 142 can be reduced as compared to the maximum potential thrust capacity of the retaining ring 142.

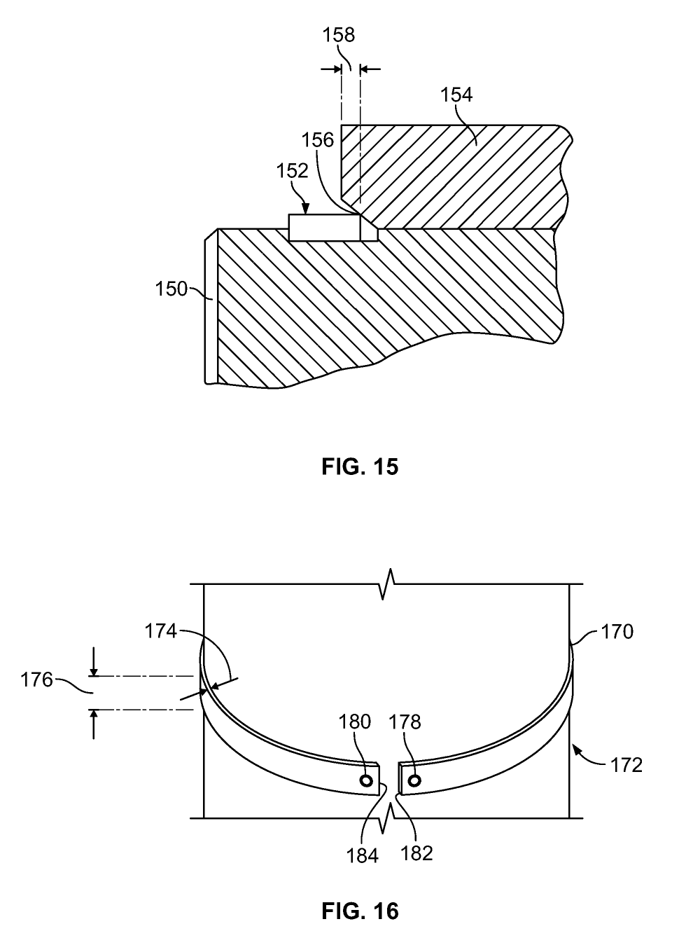

FIG. 15 illustrates an application where a retaining ring 152 is positioned in a groove on a shaft 150. An adjacent component 154, having a chamfered edge, contacts the retaining ring 152 at a contact point 156, and a portion of the adjacent component 154 overlaps the retaining ring 152 by an amount 158. Because of the low radial profile of retaining ring 152, the adjacent component 154 can overhang the retaining ring 152, which can assist in preventing the retaining ring from coming out of the groove for such things as vibration, shock loads, or rotational capacity. The contact angle between the retaining ring and the adjacent component can be any suitable angle to accomplish a desired amount of overlap. With conventional retaining rings, such overlap is avoided, which can result in a retaining ring coming out of its groove as a result of vibration, rotation or other external force and potentially damage the assembly.

Retaining rings are preferably removable, so that they can be removed in the field to allow removal of the components that they support. Retaining rings of the present technology tend to be significantly easier to install and remove from their grooves than conventional retaining rings. Without being bound by any particular theory, it is believed that because retaining rings of the present technology have a thin radial width, they tend to be pliable because they deflect with respect to the thinner dimension of the cross-section as opposed to a thicker dimension. Conventional retaining rings have a much wider radial dimension, and are thus more difficult to deflect since they deflect around that thicker dimension of the ring.

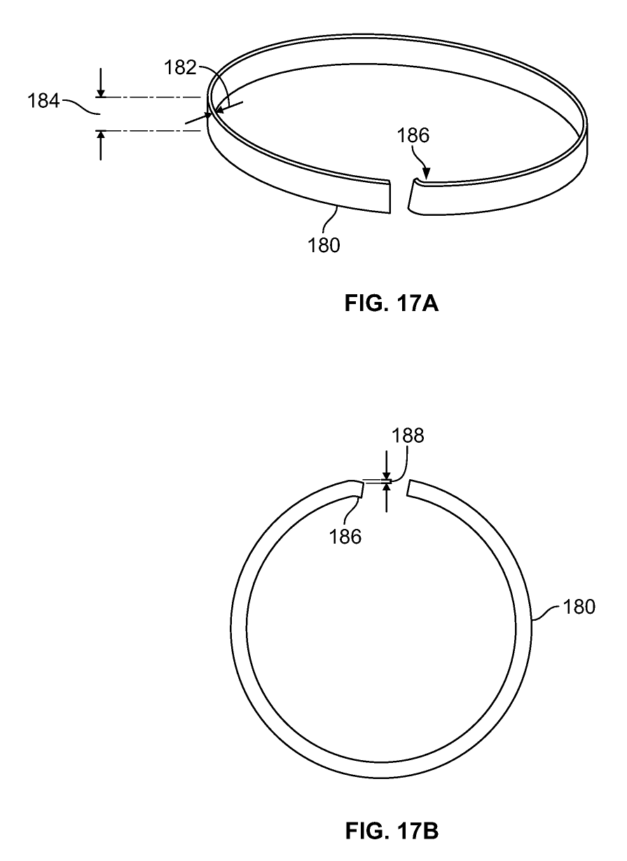

With respect to installing and removing retaining rings, the industry has developed tools that are used to manipulate retaining rings. In the design of some retaining rings, there are holes in the ends of each ring for use with pliers designed for retaining rings. The pliers have round tips that fit into the ring's holes that will expand or contract the ring for installation or removal. Other rings may be removed using a blunt object such as a screwdriver or dental pick. FIGS. 16, 17A and 17B illustrate retaining rings of the present technology having features that can accommodate the use of tools in removing the rings from a groove on a shaft or within a bore. It is particularly preferred that retaining rings for use within a bore be formed with such features, to assist in ensuring easy removal by preventing the retaining ring from spinning within the groove during removal.

FIG. 16 illustrates a retaining ring 172 on a shaft 170. Retaining ring 172 has removal holes 178 and 180 at the ends of the retaining ring 172, to facilitate the removal of the ring using conventional snap ring pliers. The pliers have tips that fit into the holes and the ring may be expanded or contracted by squeezing the ring or expanding the ring. In particular, the retaining ring 172 has a radial width 174, an axial thickness 176, a first end 182 having a first removal hole 178, and a second end 184 having a second removal hole 180.

FIGS. 17A and 17B show an example of a retaining ring 180 having a radial width 182 and an axial thickness 184. At least one end of the retaining ring 180 also includes a bend 186, to provide a small space between the ring and the groove for a screwdriver or other blunt object to enter, to pry the ring radially and remove it. The bend can be located at the first end or the second end of the retaining ring 180. Alternatively, the retaining ring could include a bend at both the first and the second end of the retaining ring.

Retaining rings of the present technology can be produced from materials that are commonly used in the retaining ring industry, including but not limited to metals that can achieve spring properties, such as, for example, high carbon spring steel, full hard 302 stainless steel, beryllium copper, phosphor bronze and inconel.

Applications for retaining rings of the present technology are virtually unlimited. Bearings, for example, are commonly situated on a shaft and located against a retaining ring in an assembly. The retaining ring needs to be removed in the field to take the bearing off and be able to replace it. Bearings typically have a large radius on their corner that would apply a load against the retaining ring, resulting in both axial and radial loading. Conventional retaining rings provide limited thrust capacity in such applications because they are designed to accommodate only axial loads, whereas the currently disclosed retaining rings can provide increased thrust capacity because they are designed to accommodate thrust loading in both an axial and radial direction. In the case of a thin walled sleeve, it is often a limitation that the groove be kept as shallow as possible. Engineers over the years have had to design in special retaining rings that accommodate shallow grooves, but the depth of the groove needs to be at a certain dimension to handle the thrust capacity primarily as a result of the moment arm resulting from ring dishing. With the use of retaining rings of the present technology, this can be less of a concern, because the groove depth needed to accommodate the retaining ring is shallower. Still another application would be what is termed an o.d./i.d. lock system. In this design a shaft and a bore are assembled together with a retaining ring that is buried within a groove in the shaft and the bore. In typical designs, the groove on one side, either the shaft or bore, is made to normal specifications. The groove on the other component in that assembly has a groove that is at least twice the radial width of the ring to allow the ring to bury itself during assembly. With conventional retaining rings, the groove depth can thus become a serious limiting factor in the design. When utilizing a hoop retaining ring in such applications, the overall requirement for the groove depth is reduced because the normal specification for groove depth is more shallow.

### EXAMPLES

Tables 1-4 below contain testing results for tests conducted on exemplary retaining rings of the present technology, as well as on comparative examples of conventional retaining rings. Tables 1 and 2 contain the test results for the exemplary retaining rings of the present technology. Tables 3 and 4 contain the test results for the comparative examples of conventional retaining rings. The columns labeled Contract Force and Expand Force of each of the tables shows the force required to expand or contract the retaining rings. As can be seen by the data, the force required to install or remove the exemplary retaining ring is substantially less than for the comparative examples.

TABLE 1
Example Retaining Rings

| | | | | | | | | THRUST | THRUST |
|---|---|---|---|---|---|---|---|---|---|
| Hoop | | | | | | | | LOAD BASED | LOAD BASED |
| Retaining | | BORE | WIRE | COMPRESSED | CONTRACT FORCE | | GROOVE | ON RING | ON GROOVE |
| Ring | FREE O.D. | DIA. | SIZE | TO | sample #1 | sample #2 | DEPTH | SHEAR | DEFORMATION |
| 1 | .789-.804 | .750 | .024 × .088 | .740 | 1.8 LBS | 1.8 LBS | .012 | 2147 LBS | 635 LBS |
| 2 | 1.044-1.064 | 1.00 | .024 × .088 | .990 | .9 LBS | .9 LBS | .012 | 2863 LBS | 847 LBS |
| 3 | 3.105-3.135 | 3.00 | .045 × .225 | 2.900 | 2.5 LBS | 2.3 LBS | .0225 | 16108 LBS | 4768 LBS |

TABLE 2
Example Retaining Rings

| | | | | | | | | THRUST | THRUST |
|---|---|---|---|---|---|---|---|---|---|
| Hoop | | | | | | | | LOAD BASED | LOAD BASED |
| Retaining | | SHAFT | WIRE | EXPANDED | EXPAND FORCE | | GROOVE | ON RING | ON GROOVE |
| Ring | FREE I.D. | DIA. | SIZE | TO | sample #1 | sample #2 | DEPTH | SHEAR | DEFORMATION |
| 4 | .696-.711 | .750 | .024 × .088 | .760 | 5 LBS | 6 LBS | .012 | 2147 LBS | 635 LBS |
| 5 | .936-.956 | 1.00 | .024 × .088 | .1010 | 2 LBS | 2 LBS | .012 | 2863 LBS | 847 LBS |

TABLE 3
Comparative Controls

| | | | | | | | | THRUST | THRUST |
|---|---|---|---|---|---|---|---|---|---|
| | | | | | | | | LOAD BASED | LOAD BASED |
| Circlip | | BORE | WIRE | COMPRESSED | CONTRACT FORCE | | GROOVE | ON RING | ON GROOVE |
| Ring | FREE O.D. | DIA. | SIZE | TO | sample #1 | sample #2 | DEPTH | SHEAR | DEFORMATION |
| 1 | .529-.542 | .500 | .035 × .055 | .490 | 34.2 LBS | 34.3 LBS | .012 | 1886 LBS | 423 LBS |
| 2 | 1.000-1.015 | .937 | .043 × .085 | .927 | 38.7 LBS | 38.6 LBS | .024 | 4312 LBS | 1582 LBS |
| 3 | 1.529-1.544 | 1.437 | .054 × .128 | 1.427 | 63.9 LBS | 63.7 LBS | .039 | 8355 LBS | 3856 LBS |
| 4 | 2.007-2.027 | 1.875 | .065 × .158 | 1.865 | 83.5 LBS | 83.7 LBS | .056 | 13044 LBS | 7418 LBS |

TABLE 4
Comparative Controls

| | | | | | | | | THRUST | THRUST |
|---|---|---|---|---|---|---|---|---|---|
| | | | | | | | | LOAD BASED | LOAD BASED |
| Circlip | | SHAFT | WIRE | EXPANDED | EXPAND FORCE | | GROOVE | ON RING | ON GROOVE |
| Ring | FREE I.D. | DIA. | SIZE | TO | sample #1 | sample #2 | DEPTH | SHEAR | DEFORMATION |
| 5 | .511-.524 | .562 | .035 × .055 | .572 | 23.0 LBS | 23 LBS | .015 | 2113 LBS | 565 LBS |
| 6 | .991-1.004 | 1.052 | .043 × .085 | 1.072 | 30.0 LBS | 29 LBS | .024 | 4915 LBS | 1794 LBS |
| 7 | 1.497-1.517 | 1.625 | .065 × .158 | 1.535 | 79.0 LBS | 79 LBS | .046 | 11384 LBS | 5277 LBS |
| 8 | 2.023-2.048 | 2.187 | .072 × .200 | 2.197 | 76.0 LBS | 77 LBS | .059 | 16968 LBS | 9113 LBS |

From the foregoing, it will be appreciated that although specific embodiments of the invention have been described herein for purposes of illustration, various modifications may be made without deviating from the spirit or scope of the invention. It is therefore intended that the foregoing detailed description be regarded as illustrative rather than limiting, and that it be understood that it is the following claims, including all equivalents, that are intended to particularly point out and distinctly claim the subject matter regarded as the invention.

What is claimed is:

1. A retaining ring for use externally on a shaft or internally within a bore, the retaining ring comprising:
a rectangular cross-section having an axial thickness and a radial width, where the axial thickness is greater than the radial width.

2. The retaining ring of claim 1, wherein a thrust load is applied to the retaining ring, and the thrust load includes an axial portion and a radial portion.

3. The retaining ring of claim 1, the retaining ring further comprising a first end, and a second end that is separated from the first end by a distance.

4. The retaining ring of claim 3, wherein the retaining ring has a first removal hole at the first end and a second removal hole at the second end.

5. The retaining ring of claim 3, wherein at least one end of the retaining ring includes a bend.

6. The retaining ring of claim 1, wherein the retaining ring is substantially circular in shape.

7. The retaining ring of claim 6, wherein the retaining ring is an external retaining ring for use on a shaft, the retaining ring having an inner diameter.

8. The retaining ring of claim 6, wherein the retaining ring is an internal retaining ring for use in a bore, the retaining ring having an outer diameter.

9. The retaining ring of claim 1, wherein the retaining ring has a ratio of axial thickness to radial width of about 20:1 or less.

10. The retaining ring of claim 1, wherein the retaining ring has a ratio of axial thickness to radial width of about 3:1 or greater.

11. An assembly utilizing a retaining ring to retain a component adjacent to a shaft or bore, the assembly comprising:
a groove for receiving a retaining ring, the groove being located on a shaft or in a bore;
a retaining ring received within the groove, the retaining ring including a rectangular cross-section having an axial thickness and a radial width, where the axial thickness is greater than the radial width; and
an adjacent component in contact with the retaining ring that is retained adjacent to the shaft or bore by the retaining ring.

12. The assembly of claim 12, wherein the retaining ring is substantially circular and has a circumference, and a minimum of about 85% of the circumference of the retaining ring has a maximum standoff between the retaining ring and the groove of up to about 0.002 inches.

13. The assembly of claim 12, wherein the retaining ring is substantially circular and has a circumference, and a maximum of about 15% of the circumference of the retaining ring can have a maximum standoff between the ring and the groove of up to about 0.004 inches.

14. The assembly of claim 12, wherein a thrust load is applied to the retaining ring by the adjacent component, the thrust load having an axial portion and a radial portion.

15. The assembly of claim 12, wherein the component has a chamfered edge and overhangs the retaining ring.

16. The assembly of claim 12, the retaining ring further comprising a first end, and a second end that is separated from the first end by a distance.

17. The assembly of claim 16, wherein the retaining ring has a first removal hole at the first end and a second removal hole at the second end.

18. The assembly of claim 16, wherein at least one end of the retaining ring includes a bend.

19. The assembly of claim 12, wherein the retaining ring has a ratio of axial thickness to radial width of about 20:1 or less.

20. The assembly of claim 12, wherein the retaining ring has a ratio of axial thickness to radial width of about 3:1 or greater.
